(19) United States
(12) Patent Application Publication
(10) Pub. No.: US 2011/0149070 A1
(43) Pub. Date: Jun. 23, 2011

(54) LIGHT SOURCE DETECTION SYSTEM AND METHOD

(75) Inventor: Hsueh Cheng Huang, Hamilton (NZ)

(73) Assignee: OPEN MINDER GROUP LIMITED, Tortola (VG)

(21) Appl. No.: 12/967,548

(22) Filed: Dec. 14, 2010

(30) Foreign Application Priority Data
Dec. 23, 2009 (TW) 098144382

(51) Int. Cl. H04N 7/18

(52) U.S. Cl. 348/135; 348/E07.085

(57) ABSTRACT

A light source detection method and system are provided. The method includes receiving incident light sources through light passing holes formed in a light spot forming board to form a light spot on an imaging board; capturing the image of the light spot and detecting the intensity thereof into divided zones so as to transmit such information that is calculated by preset algorithms to a processing device for identification, thereby improving on the drawbacks of prior techniques to achieve better accuracy of light sources and efficiency in use.

### BACKGROUND OF THE INVENTION

1. Field of the Invention

This invention relates to light source detection methods and systems, and more particularly, to a method and system for detecting position information and intensity information of an incident light source.

2. Description of Related Art

With the promotion of environment protection, a variety of green, environment-friendly energy, such as wind energy, water energy, and light energy, especially, are more and more popular in daily life. Solar energy is one kind of light energy, and is one of the most stable, abundant, and environment-friendly energy sources in the world up to today.

The incident angle of sunlight changes on a daily basis and on a seasonal basis. Modern light source detection products, such as a solar photovoltaic panel, is generally capable of incident light source detection. Large-scaled solar energy equipment further comprise a quadrant detector. The quadrant detector dynamically detects the location of a light source and changes the location of a light source reception instrument, so as to improve the usage efficiency of the light source. Since the working quadrant detector has to sample and scan the light source constantly, determine location information of the light source, and control the location and angle of the light source reception instrument, the whole detection process and detection method are complicated and time-consuming. Additionally, the updating rate of the sampling is low, which results in the generation of great errors in determining results, such that the incident light source may not be determined accurately. On the other hand, no method may detect nonparallel light source.

Therefore, it is imperative to provide a light source detection method and system for detecting the location information and intensity information of incident parallel or nonparallel light and reducing detection errors.

### SUMMARY OF THE INVENTION

In view of the above-mentioned problems of the prior art, the present invention provides a light source detection method and system for measuring position information and intensity information of an incident light source.

The light source detection method is applicable to a system having an imaging board, a light spot forming board and a processing device, and includes the following steps of: (1) receiving an incident light source through a light-passing hole of the light spot forming board, to form a light spot on the imaging board; (2) capturing an image of the light spot and detecting light intensity distribution zones, and transmitting the image and the light intensity distribution zones to the processing device; and (3) enabling the processing device to identify the image of the light spot and the light intensity distribution zones of the light spot and to calculate position information and intensity information of a light source corresponding to the light spot.

In an embodiment, step (1) further includes setting a position where the light-passing hole of the light spot forming board is vertically corresponding to the imaging board to be a central base point, and extending from the central base point toward four sides a certain distance and setting as east (E), south (S), west (W) and north (N) extreme value reference points, respectively.

In another embodiment, step (3) further includes: (3-1) identifying the image of the light spot through the processing device, to obtain an image pixel x of the light spot; (3-2) measuring a distance c between the image pixel x of the light spot and the central base point, and measuring a distance e from the central base point to the light spot forming board; (3-3) selecting one of the east (E), south (S), west (W) and north (N) extreme value reference points and measuring a distance b between the image pixel x of the light spot and the selected extreme value reference point; (3-4) measuring a distance value a between the selected extreme value reference point and the central base point; and (3-5) calculating a direction angle value α of the light source with a formula (a²+c²−b²)/2ac=cos α, and calculating an incident angle value β of the light source with another formula arctan(c/e)=β.

The light source detection system is applicable to measuring position information and intensity information of an incident light source, and includes: an imaging board configured to receive the incident light source and defined with a central base point; a light spot forming board having a light-passing hole, the light spot forming board being parallel to the imaging board, the light-passing hole being penetrable by a normal to the imaging board at the central base point, wherein the incident light source passes through the light-passing hole to form a light spot on the imaging board; a radiation detection device for detecting light intensity distribution zones of the light spot; an image-capturing device for capturing an image of the light spot; and a processing device for identifying the light intensity distribution zones and the image of the light spot, to calculate, with a preset algorithm, the position information and the intensity information of the light source corresponding to the light spot.

Therefore, the light source detection system and the method of the present invention identify and calculate the incident parallel light source or nonparallel light source to obtain the position information and the intensity information of the light source, and amend the horizontal height or angle inconsistency of light source detection equipment due to topography difference in accordance with various compensation parameters, so as to reduce the calculation errors of the position information and the intensity information of the incident light source, and provide a user with more accurate, more convenient and cheaper light source processing equipment (e.g., solar light reflection mirrors). Therefore, the usage efficiency of the light source is improved.

### BRIEF DESCRIPTION OF DRAWINGS

The invention can be more fully understood by reading the following detailed description of the preferred embodiments, with reference made to the accompanying drawings, wherein:

FIG. 1 is a basic structural diagram of a light source detection system of the present invention;

FIG. 2 is a schematic diagram illustrating that a light source detection system of the present invention finds out an incident angle value of a light source;

FIG. 3 is a schematic diagram illustrating that a light source detection system of the present invention finds out a direction angle value of a light source;

FIG. 4 is a schematic diagram illustrating a light spot measurement principle of a light source detection system of the present invention;

FIG. 5 is a system structural diagram of an embodiment of a light source detection system of the present invention;

FIG. 6 is a basic flow chart of a light source detection method of the present invention; and

FIG. 7 is a flow chart of an embodiment of a light source detection method of the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

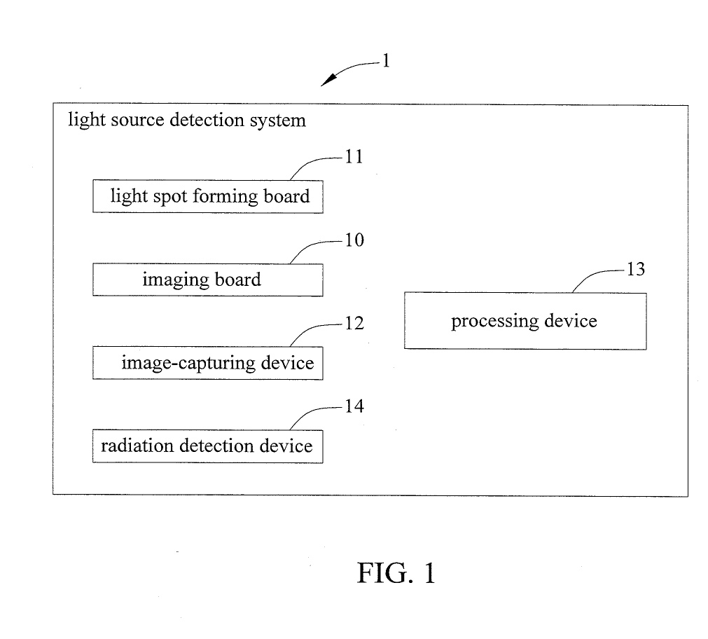

Please refer to FIG. 1, which is a basic structural diagram illustrating a light source detection system 1 of the present invention. As shown in the drawing, the light source detection system 1 of the present invention is applicable to measure position information and intensity information of an incident light source, and comprises an imaging board 10, a light spot forming board 11, an image-capturing device 12, a processing device 13 and a radiation detection device 14. The imaging board 10 is defined with a central base point thereon and configured to receive an incident light source. The light spot forming board 11 is provided with a light-passing hole thereon and positioned above the imaging board 10. The light spot forming board 11 is parallel to the imaging board 10. The light-passing hole is penetrable by a normal to the imaging board 10 at the central base point defined thereon. The incident light source passes through the light-passing hole to form a light spot on the imaging board 10. The image-capturing device 12 is for capturing an image of the light spot. The radiation detection device 14 is for detecting light intensity distribution zones (i.e., distribution zones of radiation levels). The processing device 13 is for identifying the image of the light spot and the light intensity distribution zones, and calculating, with a preset algorithm, the position information and the intensity information of the light source corresponding to the light spot.

In an embodiment, the light source detection system 1 may be applied to a solar energy light source, and the processing device 13 is for calculating position information of the solar energy light source and radiation intensity information of the solar energy light source.

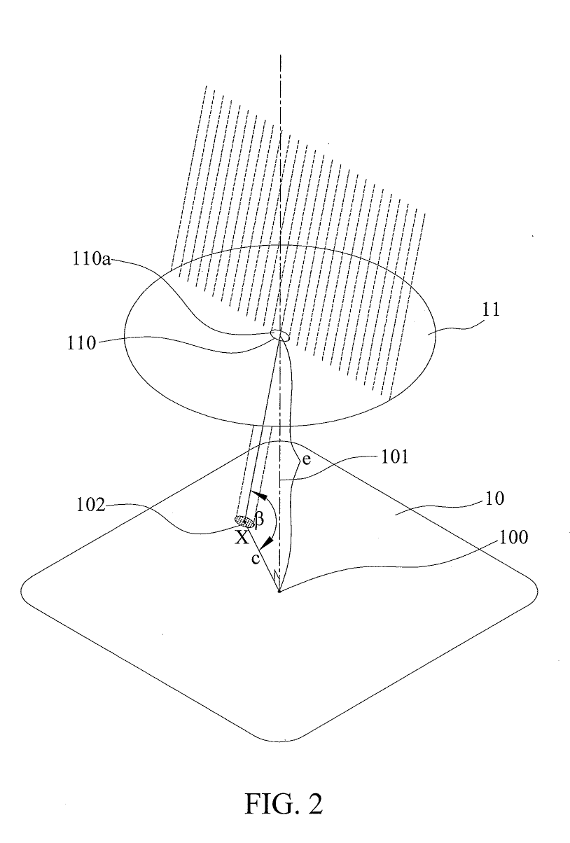

Refer to FIG. 2, which is a schematic diagram illustrating that a light source detection system of the present invention finds out an incident angle value of a light source. A light-passing hole 110 of the light spot forming board 11 is configured to receive parallel light beams, so as to form a light spot 102 on the imaging board 10. Then, an image-capturing device (not shown) is enabled to capture an image of the light spot 102, and the radiation detection device 14 is enabled to detect a radiation level of the light spot 102, and input the image and the radiation level of the light spot 102 into the processing device 13 for calculation. Calculation of an incident angle value of the light source is described below.

In the beginning, a central base point 100 is defined on the imaging board 10, and a normal 101 is defined as the normal to the imaging board 10 at the central base point 100. The normal 101 penetrates the light-passing hole 110 of the light spot forming board 11. An image pixel x of the light spot 102 is obtained. The distance c between the image pixel x of the light spot 102 and the central base point 100 is measured. The distance e along the normal 101 from the light-passing hole 110 to the light spot forming board 11 is measured. Finally, an incident angle value β of the light source is calculated by trigonometric function arctan(c/e).

In an embodiment, a light-passing lens 110a may be installed on the light-passing hole 110, and the light-passing lens 110a may be a convex lens or a concave lens, for generating convergent light or divergent light effects when receiving a nonparallel light source. When an incident nonparallel light source is received, a gradient light spot 102 is formed on the imaging board 10. Where the light-passing lens 110a is the convex lens, the light spot 102 looks centrally convergent and peripherally divergent. Where the light-passing lens 110a is the concave lens, the light spot 102 looks centrally divergent and peripherally convergent.

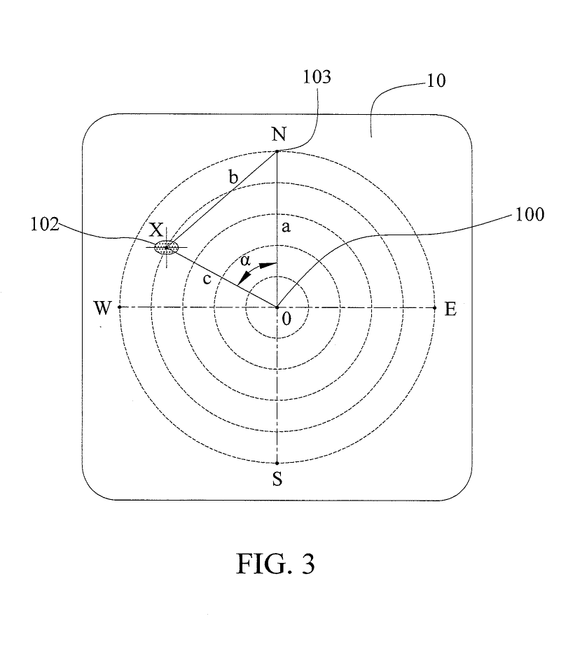

Please refer to FIG. 3, which is a schematic diagram illustrating that a light source detection system of the present invention finds out a direction angle value of a light source. In FIG. 2, the system of the present invention finds out the incident angle value β of an incident light source, and therefore knows a tilt angle of the light source and the imaging board 10. However, in any point in four quadrants within 360 degrees concentric circles with the central base point 100 as the center and the distance c of image pixel x (of the light spot 102) therefrom as the radius, a plurality of incident angle values β having the same values may be obtained. The position angle value of the light source has to be obtained, in order to accurately position where the light source is positioned in the four quadrants. Referring to FIG. 2 and FIG. 3, the normal 101 to the imaging board 10 at the central base point 100 thereof penetrates the light-passing hole 110 of the light spot forming board 11, and the imaging board 10 are defined thereon with east (E), south (S), west (W), and north (N) extreme value reference points 103 which lie to the east, the south, the west, and the north of the central base point 100, respectively, and are spaced apart from the central base point 100 by a specific distance. The east (E), south (S), west (W), and north (N) extreme value reference points 103 are configured for horizontal vertical positioning. After one of the extreme value reference points 103 (taking the north (N) extreme value reference point as an example) is selected, the processing device 13 calculates the distance a between the central base point 100 and the north (N) extreme value reference point 103, the distance c between the image pixel x of the light spot 102 and the central base point 100, and the distance b between the image pixel x of the light spot 102 and the north (N) extreme value reference point 103, then calculates the direction angle value α by using the cosine formula (a²+c²−b²)/2ac=cos α, and determines the position information of the light source in accordance with the incident angle value β.

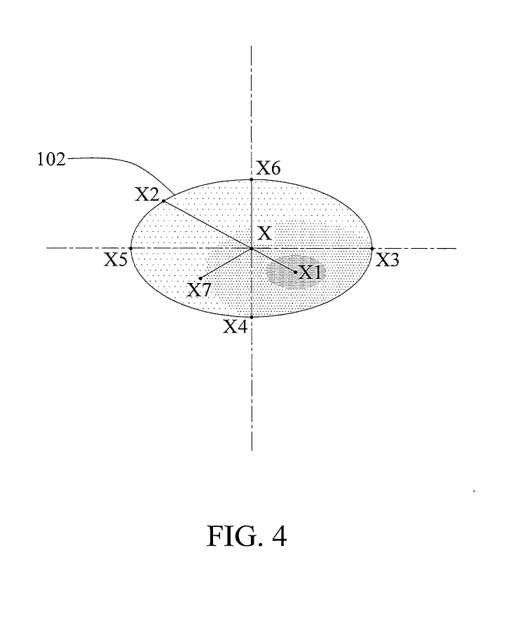

Please refer to FIG. 4, which is a schematic diagram illustrating a light spot measurement principle of a light source detection system of the present invention. FIG. 4 shows a state of the light spot 102 when the processing device 13 identifies the image and light intensity distribution zones of the light spot 102. Since the light spot 102 does not converge to one point, when the incident light source is received through the light-passing hole 110 of the light spot forming board 11, a light spot 102 is formed on the imaging board 10. Through the scanning of the radiation detection device 14 and/or the image-capturing device 12, different zones of the light spot 102 are displayed with different light intensity, a light intensity distribution zone that has the greatest light intensity value being the most central point of the light spot 102. As shown in the drawing, the system may capture an absolute central point x, an intensity central point x1, a weakest intensity point x2, an east (E) corresponding point x3, a south (S) corresponding point x4, a west (W) corresponding point x5, a north (N) corresponding point x6 of the light spot 102 or other central base point x7 of the light spot. Therefore, if only one point of the light spot 102 is measured in accordance with the position angle value and incident angle value of the light source, the measured value may have errors. On the contrary, if a plurality of the above points are captured to calculate the position angle value and incident angle value of the light source, through average or weight calculation, the position information of the light source may be determined accurately.

Further, the tint of the image of the light spot 102 may be determined according to the gradient distribution (radiation level distribution) within the image range of the light spot 102, such that the intensity of the light source and the tilt angle of the light source may be determined. When the image of the light spot 102 has a great tint, the tilt angle of the light source is small and the intensity of the light source is great. When the image of the light spot 102 has a small tint, the tilt angle of the light source is great and the intensity of the light source is small.

Also, the intensity of the light source may be determined according to the size of the image of the light spot 102. The larger the image of the light spot 102 is, the weaker the intensity of the light source becomes. On the contrary, the smaller the image of the light spot 102 is, the greater the intensity of the light source becomes. As shown in the drawing, the x1 circumference is the darkest and corresponds to a light source that has a great intensity, while x2, the outmost circumference of the light spot, is the brightest and corresponds to a light source that has a weaker intensity, as compared to x1.

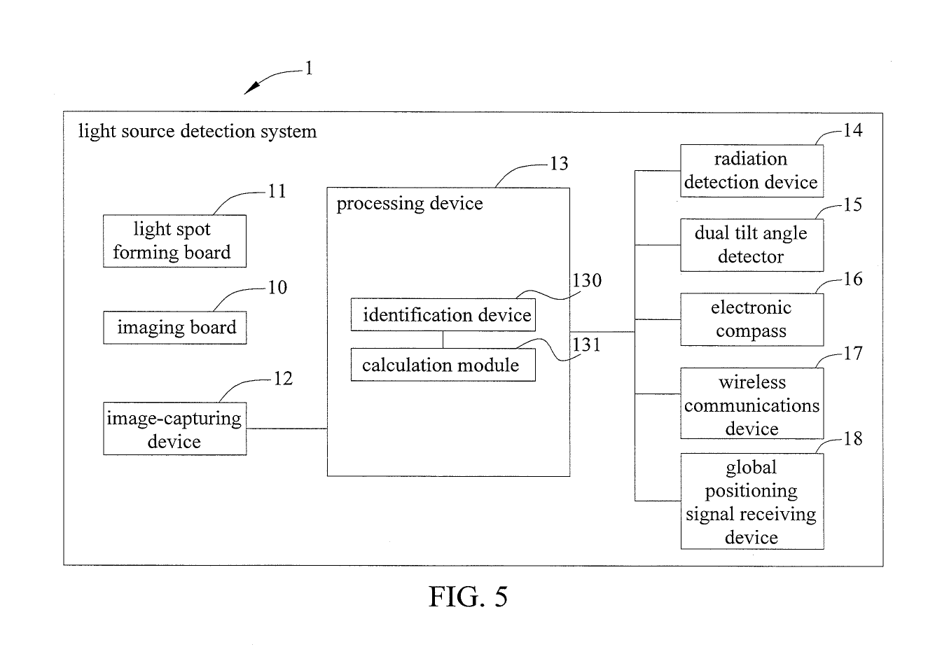

Please refer to FIG. 5, which is a system structural diagram of an embodiment of a light source detection system of the present invention. In the embodiment, the processing device 13 is a central processor which comprises an identification device 130 and a calculation module 131, for identifying the image and light intensity distribution zones of the light spot 102 and calculating position information and intensity information of a light source corresponding to the light spot 102. The system further comprises a dual tilt angle detector 15, an electronic compass 16, a wireless communications device 17 and a global positioning signal receiving device 18, for assisting the processing device 13 to improve the accuracy of light source detection.

The dual tilt angle detector 15 detects the tilt angle of the imaging board. The electronic compass 16 detects the direction value of the imaging board, and transmits the tilt angle value and the direction value of the imaging board to the processing device for horizontal compensation calculation. In practice, the system of the present invention, after installed, may have some errors with respect to a horizontal angle (and an angle error of a horizontal angle of the light spot forming board and the imaging board), due to the different topography. Through the tilt angle value and the direction value calculated by the dual tilt angle detector 15 and the electronic compass 16, the errors are corrected, so as to compensate for the imaging board 10 to maintain at a common height and plane to perform calculation, and ensure the measurement accuracy of the position information and intensity information of the incident light source.

Moreover, the plurality of light source detection systems, when installed at various areas, may have height drop and angle tilt problems generated, because the various areas are different in altitude and topography. Through the obtaining of the positioning signal and height signal by the global positioning signal receiving device 18, the light source detection system may use the wireless communications device 17 to transmit the above signals to a central controlled platform for calculation, so as to compensate for errors generated due to the height drop and angle tilt.

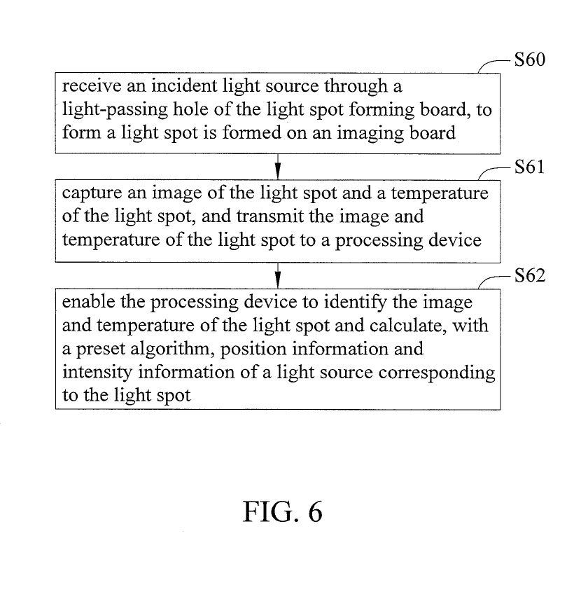

Please refer to FIG. 6, which is a basic flow chart of a light source detection method of the present invention. The light source detection method is applicable to a system having an imaging board, a light spot forming board and a processing device. As shown in the drawing, initially in step S60 an incident light source is received through a light-passing hole of the light spot forming board, and a light spot is formed on the imaging board. Proceed to step S61.

In step S61, an image and light intensity distribution zones of the light spot are captured, and transmitted to the processing device. Proceed to step S62.

In step S62, the processing device is enabled to identify and calculate, with a preset algorithm, the image and light intensity distribution zones of the light spot, so as to obtain position information and intensity information of a light source corresponding to the light spot.

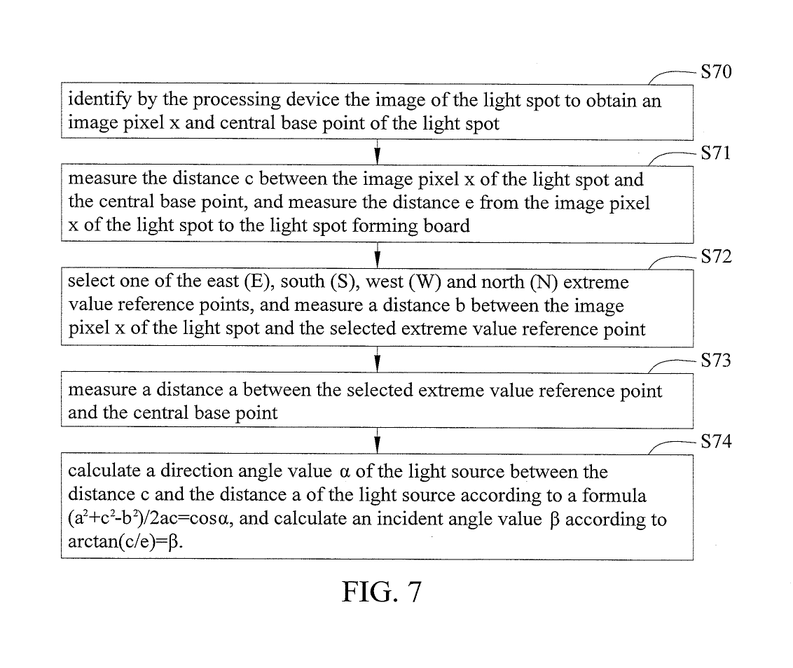

Please refer to FIG. 7, which is a flow chart of an embodiment of the light source detection method of the present invention. Initially, in step S70 the processing device identifies the image of the light spot to obtain an image pixel x and central base point of the light spot. Proceed to step S71.

In step S71, the distance e between the image pixel x of the light spot and the central base point is measured, and the distance e from the image pixel x of the light spot to the light spot forming board is also measured. Proceed to step S72.

In step S72, one of the east (E), south (S), west (W) and north (N) extreme value reference points is selected, and the distance b between the image pixel x of the light spot and the selected extreme value reference point is measured. Proceed to step S73.

In step S73, the distance a between the selected extreme value reference point and the central base point is measured. Proceed to step S74.

In step S74, a direction angle value a of the light source is calculated according to the cosine formula (a²+c²−b²)/2ac=cos α, and an incident angle value β is calculated according to an inverse trigonometric function arctan(c/e)=β.

A calculation method for a solar incident angle (α) and a solar direction angle (as) is described in the following paragraphs with a solar angle as an example. The solar incident angle (α) is an included angle between solar light and a horizontal plane, and the solar direction angle (as) is another included angle between the projection of the solar light upon the horizontal plane and a local meridian, with the north as zero degree. The solar incident angle (α) and the solar direction angle (as) relate to geographic latitude, the location of the sun when emitting light directly onto the Earth (Declination), and hour angle. The calculation formulas are as follows:

sin α=sin L sin δₛ+cos L cos δₛ cos hs (1)

sin as =cos δₛ sin hₛ/cos α (2)

where L is geographical latitude, δ s is declination, and hₛ is hour angle. The declination is an angle distance measured from equinoctial, along circle of right ascension of the sun, to the sun in the equator coordinate. The sun, in equinoctial, takes north as position, and south as negative, and ranges from 0 to ±23.44. The calculation formula is:

δₛ=23145 sin (360°(284+N)/365) (3)

where N is day series, e.g., January 1st as 1, as so on, December 31st as 365. The hour angle describes the movement of the sun during 24 hours, with local true solar time noon as zero degree, afternoon as positive, morning as negative, and 15, degrees per hour. The calculation formula is as follows:

hₛ=15*(h−12) (4)

Day length, sun-rising time (hₛᵣ) and sun-set time (hₛₛ) are described now. The time interval between the sun-rising time and the sun-set time is the day length. The solar incident angle at the sun-rising time and the sun-set time is zero, i.e.,

sin α=0=sin L sin δₛ+cos L cos δₛ cos hₛᵣ (5)

hₛᵣ=cos⁻¹(−tan L tan δₛ) (6)

hₛₛ=hₛᵣ (7)

Through the above calculation formulas, the solar incident angle (α) and sun direction angle (as) may be found, thereby setting the direction where the sun is located precisely. Additionally, when the sunlight is incident directly upon the upper boundary of atmosphere, the calculation formula for the solar radiation intensity is:

I₀=S₀(1+010344 cos (360° N/365)) (W·m⁻²) (8)

The calculation formula takes into consideration a circumstance that the solar radiation intensity upon the upper boundary of atmosphere varies due to the variance of the distance between the sun and the earth during a year. Sₒ is a solar radiation constant, i.e., a solar radiation flux per unit area on the upper boundary of atmosphere perpendicular to direction along which the sun directly shines on the earth. There are many ways to set the value. In the preferred embodiment, the value may be set to be 1367 W·m⁻². The calculation of the solar radiation intensity, together with the location information of the incident light source, is advantageous to the usage and adjustment of solar energy application equipment (e.g., a reflection mirror).

Therefore, the present invention uses a light spot forming board, an imaging board and a processing device to identify and calculate an incident light source and obtain position information and intensity information of the incident light source, and amends the horizontal height or angle inconsistency of light source detection equipment due to topography difference in accordance with various compensation parameters, so as to reduce the calculation errors of the position information and the intensity information of the incident light source, and provide a user with more accurate, more convenient and cheaper light source processing equipment (e.g., solar light reflection mirrors). Therefore, the usage efficiency of the light source is improved.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A light source detection method applicable to a system having an imaging board, a light spot forming board and a processing device, the light source detection method comprising the steps of:
(1) receiving an incident light source through a light-passing hole of the light spot forming board, to form a light spot on the imaging board;
(2) capturing an image of the light spot and detecting light intensity distribution zones of the light spot, and transmitting the image and the light intensity distribution zones to the processing device; and
(3) enabling the processing device to identify the image of the light spot and the light intensity distribution zones of the light spot and to calculate, with a preset algorithm, position information and intensity information of a light source corresponding to the light spot.

2. The light source detection method of claim 1, wherein the incident light source is a parallel light source or a nonparallel light source.

3. The light source detection method of claim 2, wherein step (1) further comprises the sub-steps of:
(1-1) installing a light-passing lens on the light-passing hole of the light spot forming board; and
(1-2) receiving the incident nonparallel light source by the light-passing hole of the light spot forming board through the light-passing lens, to form a gradient light spot on the imaging board.

4. The light source detection method of claim 3, wherein the light-passing lens is a convex lens or a concave lens for generating convergent light or divergent light effects.

5. The light source detection method of claim 4, wherein the gradient light spot looks centrally convergent and peripherally divergent when the lens is the convex lens, and the gradient light spot looks centrally divergent and peripherally convergent when the lens is the concave lens.

6. The light source detection method of claim 1, wherein step (1) further comprises setting a central base point to a position at which a normal to the imaging board penetrates the light-passing hole of the light spot forming board, and defining on the imaging board east (E), south (S), west (W), and north (N) extreme value reference points lying to the east, the south, the west, and the north of the central base point, respectively, and spaced apart from the central base point by a specific distance.

7. The light source detection method of claim 1, wherein an image-capturing device pre-forms a zone corresponding to the imaging board to capture an image of the light spot located at the zone.

8. The light source detection method of claim 1, wherein the processing device is a central processor or a digital signal processor.

9. The light source detection method of claim 1, wherein step (3) further comprises the sub-steps of:
(3-1) identifying the image of the light spot through the processing device, to obtain an image pixel x of the light spot;
(3-2) measuring a distance c between the image pixel x of the light spot and the central base point, and measuring a distance e between the central base point and the light spot forming board;
(3-3) selecting one of east (E), south (S), west (W) and north (N) extreme value reference points and measuring a distance b between the image pixel x of the light spot and the selected extreme value reference point;
(3-4) measuring a distance a between the selected extreme value reference point and the central base point; and
(3-5) calculating a direction angle value α of the light source with a formula (a²+c²=b²)/2ac=cos α, and calculating an incident angle value β of the light source with another formula arctan(c/e)=β.

10. The light source detection method of claim 9, wherein the image pixel x of the light spot is an absolute central point, an intensity central point, an intensity minimum point, an east (E) corresponding point, a south (S) corresponding point, a west (W) corresponding point, a north (N) corresponding point of the light spot or another central base point of the light spot.

11. A light source detection system applicable to measuring position information and intensity information of an incident light source, the light source detection system comprising:
an imaging board configured to receive the incident light source and defined with a central base point;
a light spot forming board provided with a light-passing hole and positioned above the imaging board, the light spot forming board being parallel to the imaging board, the light-passing hole being penetrable by a normal to the imaging board at the central base point, wherein the incident light source passes through the light-passing hole to form a light spot on the imaging board;
a radiation detection device for detecting light intensity distribution zones of the light spot;
an image-capturing device for capturing an image of the light spot; and
a processing device for identifying the light intensity distribution zones and the image of the light spot, so as to calculate, with a preset algorithm, the position information and the intensity information of the light source corresponding to the light spot.

12. The light source detection system of claim 11, wherein a light-passing lens is installed on the light-passing hole of the light spot forming board, and the light-passing lens is a convex lens or a concave lens.

13. The light source detection system of claim 11 further comprising a dual tilt angle detector for sensing a tilt angle value of the imaging board and transmitting the tilt angle value of the imaging board to the processing device for horizontal compensation calculation of the light spot.

14. The light source detection system of claim 11 further comprising an electronic compass for detecting a direction value of the imaging board and transmitting the direction value to the processing device for horizontal compensation calculation of the light spot.

15. The light source detection system of claim 11 further comprising a global positioning signal receiving device for obtaining positioning signals and height signals and transmitting the positioning signals and the height signals to the processing device to compensate for the position information of the light source corresponding to the light spot.

16. The light source detection system of claim 11 further comprising a wireless communications device for transmitting the position information and the intensity information generated by the processing device.

17. The light source detection system of claim 11, wherein the light source is a solar energy light source, and the processing device calculates position information of the solar energy light source and radiation intensity information of the solar energy light source.
